(19) United States
(12) Patent Application Publication
(10) Pub. No.: US 2025/0373011 A1
(43) Pub. Date: Dec. 4, 2025

(54) ROBUST ELECTRICAL POWER SUPPLY ASSEMBLY WITH ADAPTIVE POWER CONTROL

(71) Applicant: Aptiv Technologies AG, Schaffhausen (CH)

(72) Inventor: Robert DEUTSCH, Shelby Township, MI (US)

(21) Appl. No.: 19/206,200

(22) Filed: May 13, 2025

Related U.S. Application Data
(60) Provisional application No. 63/652,794, filed on May 29, 2024.
(60) Provisional application No. 63/668,812, filed on Jul. 9, 2024.

(51) Int. Cl. H02J 1/10; H02M 1/00; H02M 1/32; H02M 1/44; H02M 3/335

(52) U.S. Cl. CPC H02J 1/102; H02M 1/0009; H02M 1/327; H02M 1/44; H02M 3/33592; H02J 2310/40

(57) ABSTRACT

An electrical power supply assembly is disclosed, comprising first and second DC/DC converters, each equipped with a current sensor to determine respective currents. The assembly includes an electrical charge storage device with a boost/buck DC/DC converter and a charge storage medium. It features voltage sensors to determine input, output, and charge storage medium voltages. An electronic controller, in communication with the converters and sensors, includes a computer-readable medium storing instructions that enable the controller to adjust the output power of the first and second DC/DC converters based on their respective currents and the input and output voltages when the output voltage is outside a predetermined range. Additionally, the controller adjusts the output power of the boost/buck DC/DC converter based on the output and charge storage medium voltages under similar conditions, ensuring efficient power management and stability of the electrical power supply assembly.

### CROSS-REFERENCE TO RELATED APPLICATIONS

This application claims the benefit of and priority to U.S. Provisional Application 63/668,812, titled “Robust Electrical Power Supply Assembly with Adaptive Power Control”, filed Jul. 9, 2024 and to U.S. Provisional Application 63/652,794, titled “Electrical Power Pack”, filed May 29, 2024, the contents of each of which are incorporated by reference herein.

### TECHNICAL FIELD

The subject matter disclosed herein relates to robust electrical power supply and, in particular, to a robust electrical power supply with adaptive control.

### BACKGROUND

Automotive Safety Integrity Level (ASIL) is a risk classification system defined by the International Organization for Standardization (ISO) 26262 standard for the functional safety of road vehicles. The standard defines functional safety as “the absence of unreasonable risk due to hazards caused by malfunctioning behavior of electrical or electronic systems.” ISO 26262 establishes safety requirements based on the probability and acceptability of harm for automotive components in case of loss of electrical power. There are four different ASIL grades identified by ISO 26262; A, B, C, and D. ASIL-A represents the lowest degree of potential automotive hazard and ASIL-D represents the highest degree. Systems like inflatable restraints, anti-lock brakes, and power steering assist require an ASIL-D grade, the highest rigor applied to safety assurance, because the risks associated with their failure are the highest. On the other end of the safety spectrum, components such as rear taillights require only the ASIL-A grade. Headlights and brake lights generally would be rated as ASIL-B while cruise control would generally be rated as ASIL-C. There is also another less stringent QM level for electrical loads. QM stands for “Quality Management” level and means that all assessed risks from inoperability of a particular load, e.g., power seats, interior lighting, etc., are tolerable from a safety perspective. Therefore, safety assurance controls are unnecessary for QM loads and ASIL standards do not need to be applied.

Existing electrical power supply assemblies typically consist of multiple DC/DC converters, voltage sensors, and current sensors to regulate and monitor the flow of electrical power within the system. These components work together to convert direct current (DC) power from one voltage level to another, store electrical charge, and ensure stable power delivery to connected devices. The DC/DC converters are responsible for converting the input voltage to the desired output voltage, while the current sensors monitor the current flow through each converter to prevent overloading and ensure efficient power distribution.

Voltage sensors are commonly used in power supply assemblies to measure the voltage levels at different points within the system. By monitoring the input and output voltages, the voltage sensors provide crucial feedback to the electronic controller, enabling it to make real-time adjustments to maintain stable power output. Additionally, current sensors play a vital role in measuring the current passing through the DC/DC converters, allowing the electronic controller to regulate the power output based on the current demands of the connected devices.

Furthermore, electrical charge storage devices, such as batteries or capacitors, are often integrated into power supply assemblies to store excess electrical energy for later use or to provide backup power in case of a power outage. These charge storage devices typically include boost/buck DC/DC converters to regulate the voltage levels of the stored energy and ensure efficient charging and discharging processes. The coordination and optimization of power output from multiple DC/DC converters and charge storage devices in response to varying voltage levels have posed challenges in achieving optimal power supply efficiency, stability, and reliability. However, none of these approaches have provided a comprehensive solution that combines the features described in this disclosure.

### SUMMARY

In some aspects, the techniques described herein relate to an electrical power supply assembly. The electrical power supply assembly includes a first direct current-to-direct current (DC/DC) converter having a first current sensor configured to determine a first current through the first DC/DC converter and a second DC/DC converter having a second current sensor configured to determine a second current through the second DC/DC converter. The electrical power supply assembly further includes an electrical charge storage device having a boost/buck DC/DC converter and a charge storage medium, a first voltage sensor configured to determine a first voltage of an input of the electrical power supply assembly, a second voltage sensor configured to determine a second voltage of an output of the electrical power supply assembly, and a third voltage sensor configured to determine a third voltage of the charge storage medium. The electrical power supply assembly additionally includes an electronic controller in electronic communication with the first and second DC/DC converters, the boost/buck DC/DC converter, the first, second, and third voltage sensors, and the first and second current sensors. The electronic controller includes a computer-readable medium that stores instructions that, when executed by the electronic controller, cause the electronic controller to perform one or more of the following functions: adjust a first output power of the first DC/DC converter based on the first current and the first and second voltages when the second voltage is outside a predetermined voltage range, adjust a second output power of the second DC/DC converter based on the second current and the first and second voltages when the second voltage is outside the predetermined voltage range, and adjust a third output power of the boost/buck DC/DC converter based on the second and third voltages when the second voltage is outside the predetermined voltage range.

In some aspects, the techniques described herein relate to an automotive electrical power supply configured to supply electrical power to at least one Automotive Safety Integrity Level (AISL) D classified electrical load in a vehicle at a predetermined power level. The automotive electrical power supply includes a first DC/DC converter configured to supply a first portion of the electrical power. The first DC/DC converter is configured to supply the first portion of the electrical power at least at the predetermined power level. The automotive electrical power supply has a second DC/DC converter configured to supply a second portion of the electrical power. The second DC/DC converter is configured to supply the second portion of the electrical power at least at the predetermined power level. The automotive electrical power supply also includes an electrical charge storage device configured to supply a third portion of the electrical power. The electrical charge storage device is configured to supply the third portion of the electrical power for a predetermined time period at least at the predetermined power level. The automotive electrical power supply further includes an electronic controller in electronic communication with the first and second DC/DC converters and the electrical charge storage device. The electronic controller is configured to perform one or more of the following functions: adjust operation of the first DC/DC converter to cause the automotive electrical power supply to maintain the predetermined power level, adjust operation of the second DC/DC converter to cause the automotive electrical power supply to maintain the predetermined power level, and adjust operation of the electrical charge storage device to cause the automotive electrical power supply to maintain the predetermined power level at least for the predetermined time period.

### BRIEF DESCRIPTION OF THE DRAWINGS

FIG. 1 is a schematic diagram of a robust electrical power supply according to some embodiments.

FIG. 2 is a schematic diagram of a DC/DC converter of the robust electrical power supply of FIG. 1 according to some embodiments.

FIG. 3 is a schematic diagram of an energy storage device of the robust electrical power supply of FIG. 1 according to some embodiments.

FIG. 4 is a graph of power availability from the robust electrical power supply of FIG. 1 according to some embodiments.

### DETAILED DESCRIPTION

With autonomous driving systems becoming more widely adopted in vehicles, ASIL rated power delivery systems are becoming a requirement to meet their power requirements. Power delivery systems meeting the ASIL D standard are being adopted in these vehicles. A single DC/DC converter in conjunction with an energy storage device, such as an ultracapacitor, can provide ASIL B rated power delivery. As presented herein, an ASIL D power delivery system is provided by using two of these ASIL B power devices as redundant devices to provide ASIL D level performance. The control algorithms and hardware architecture are the key to deliver ASIL D level performance using the lower cost ASIL B hardware. The robust electrical power supply using dual DC/DC converters and an ultracapacitor based energy storage device provides a more economical way of achieving ASIL D level power delivery. The robust electrical power supply is configured to be connected to a high voltage DC power input, such as the battery pack of an electrical vehicle, and supply a reliable lower voltage DC power output to sensors, actuators, and electronic control modules in a vehicle.

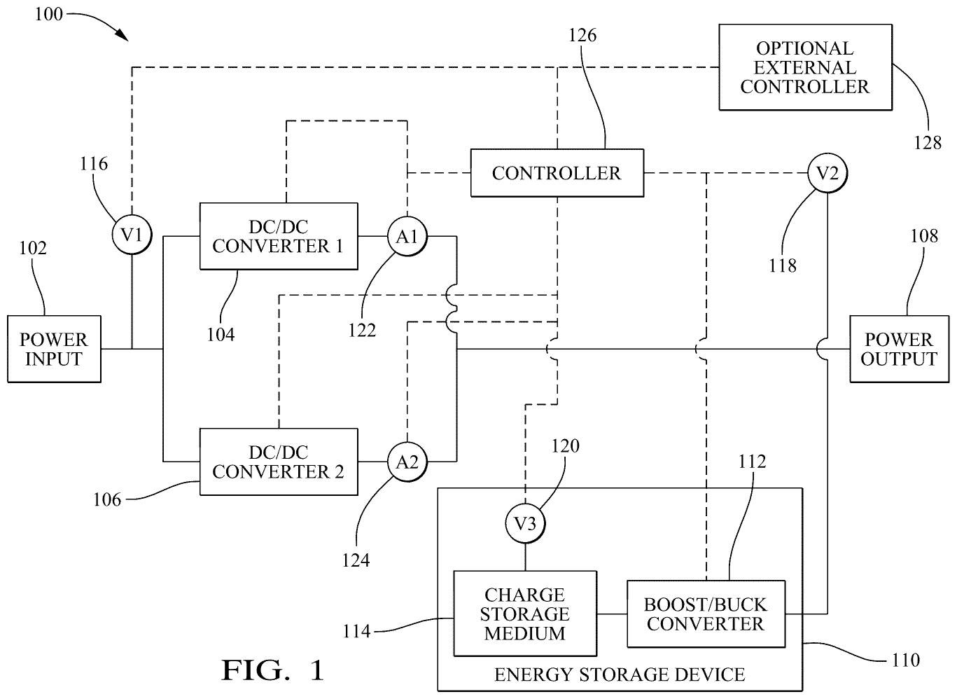

FIG. 1 shows a schematic diagram of an ASIL-D compliant electrical power supply 100 having a power input 102 that is configured to be connected to a high voltage electrical power supply, such as a battery of an electric vehicle (not shown). The electrical power supply 100 includes a first direct current-to-direct current (DC/DC) converter 104 and a separate and substantially identical second DC/DC converter 106 that are connected in parallel to the power input 102. The DC/DC converters 104 and 106 are configured to step down the higher DC voltage of the high voltage electrical power supply to a lower DC voltage used by electrical loads connected to a power output 108. The DC voltage required at the power output 108 is defined by a voltage range. In some embodiments the voltage range is predetermined. The first and second DC/DC converters 104, 106 are redundant and sized such that one of the DC/DC converters 104, 106 can provide voltage within a predetermined voltage range at least at the rated power level of the electrical power supply 100 in case the other DC/DC converter 106, 104 fails.

The electrical power supply 100 has an electrical charge storage device 110 that is also connected to the power output 108. The electrical charge storage device 110 is configured to store electrical energy when the voltage at the power output 108 exceeds an upper limit of the predetermined voltage range and release electrical energy when the voltage at the power output falls below the lower limit of the predetermined voltage range. The electrical charge storage device 110 is sized such that it can provide power within the predetermined voltage range at least at the rated power level of the electrical power supply for a limited time, e.g., 10 to 20 second, in case both of the DC/DC converters 104 and 106 fail to provide an orderly shutdown of all systems powered by the electrical power supply 100. In some embodiments, the electrical charge storage device 110 includes a boost/buck DC/DC converter 112 that is connected to the power output 108 and a charge storage medium 114, e.g., an ultracapacitor or battery, connected to the boost/buck DC/DC converter 112.

The electrical power supply 100 also has an array of voltage and current sensors configured to monitor and control operation of the electrical power supply 100. A first voltage sensor 116 is configured to determine a first voltage at the power input 102 of the electrical power supply 100. In some embodiments, the electrical power supply 100 may comprise several power supplies have different voltages e.g., example 14V and 48V, 350V and 14V, or 800V and 14V. In this case the first voltage sensor 116 comprises two separate voltage sensors to determine each of the voltage of the power supply 100, A second voltage sensor 118 is configured to determine a second voltage at the power output 108. A third voltage sensor 120 is configured to determine a third voltage of the charge storage medium 114. A first current sensor 122 is configured to determine a first current through the first DC/DC converter 106 and a second current sensor 124 is configured to determine a second current through the second DC/DC converter 104.

The electrical power supply 100 further includes an electronic controller 126 that is configured to be in electronic communication with the first and second DC/DC converters 104, 106, the boost/buck DC/DC converter 112, the first, second, and third voltage sensors 116, 118, 120 and the first and second current sensors 122, 124. In the figures, electronic communication paths are indicated by dashed lines. The electronic controller 126 has a nonvolatile computer-readable medium that stores instructions, e.g., software, that, when executed by the electronic controller, cause the electronic controller to perform one or more of the following functions:

Adjust a first output power of the first DC/DC converter 104 based on the first current and the first and second voltages when the second voltage is outside the predetermined voltage range. For example, this adjustment of the first output power may occur due to malfunctioning of the second DC/DC converter 106. This adjustment of the first output power may alternatively occur due to a voltage sag or a voltage spike at the power output 108 caused by turning on or turning off of an electrical load (not shown) connected to the power output 108.

Adjust a second output power of the second DC/DC converter 106 based on the second current and the first and second voltages when the second voltage is outside the predetermined voltage range. For example, this adjustment of the second output power may occur due to malfunctioning of the first DC/DC converter 104. This adjustment of the second output power may alternatively occur due to a voltage sag or a voltage spike at the power output 108 caused by turning on or turning off of an electrical load (not shown) connected to the power output 108.

Adjust a third output power of the boost/buck DC/DC converter 112 based on the second and third voltages when the second voltage is outside the predetermined voltage range. For example, this adjustment of the third output power may occur due to malfunctioning of the first DC/DC converter 104 and/or the second DC/DC converter 106. This adjustment of the third output power may alternatively occur due to a voltage sag or a voltage spike at the power output 108 caused by turning on or turning off of an electrical load (not shown) connected to the power output 108.

The electronic controller 126 may be configured to receive the predetermined voltage range from another electronic controller 128 that is external to the electrical power supply 100, such as a vehicle control module connected to the electrical power supply by a controller area network or local interface network communication bus. The electronic controller 126 may then store the predetermined voltage range in the nonvolatile computer-readable medium for future calculations and determination.

The computer-readable medium of the electronic controller 126 may further contain instructions that, when executed by the electronic controller 126, cause the electronic controller 126 to operate the boost/buck DC/DC converter 112 in buck mode to suppress voltage spikes and hold the second voltage within the predetermined voltage range. For example, in response to the second voltage monitored at the power output exceeding the predetermined voltage range, the electronic controller 126 may cause the boost/buck DC/DC converter 112 to operate in buck mode to store excess energy to the charge storage medium 114.

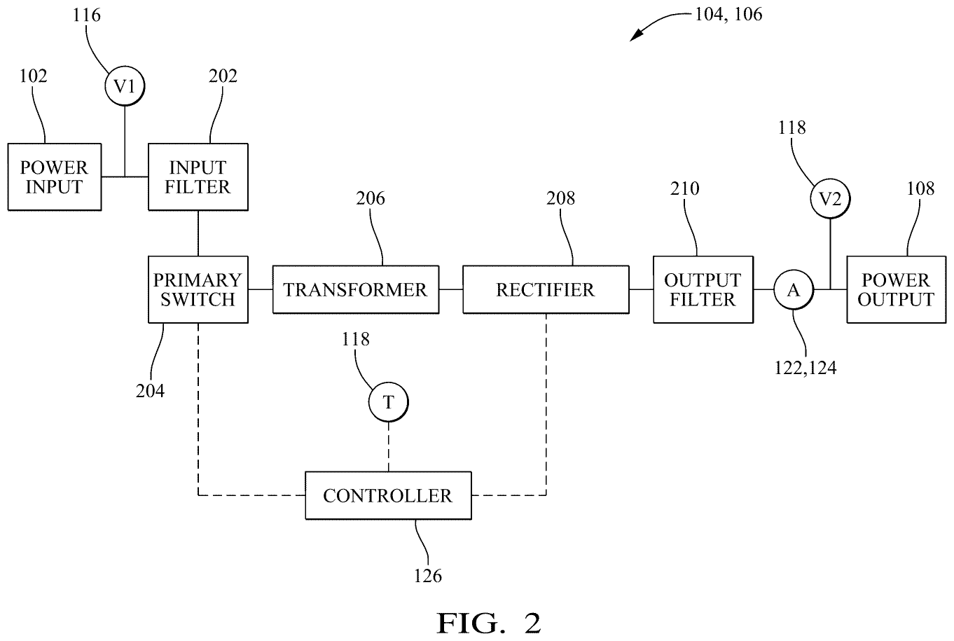

FIG. 2 shows a more detailed schematic diagram of the first and second DC/DC converters 104, 106. These DC/DC converters 104, 106 may be “protected,” i.e., the DC/DC converters 104, 106 are permanently connected to the high voltage power supply, e.g., a battery, without a disconnect. The first and second DC/DC converters 104 106 have an input filter 202 that is connected to the power input 102 and is configured to filter out electromagnetic interference (EMI) that may be present at the power input 102. The filtered high power DC voltage flows to a primary switch 204 that is switched at a rate determined by the electronic controller 126 to provide an alternating current (AC) voltage that is output to a transformer 206. The transformer 206 steps down the high DC voltage of the power input 102 to the lower DC voltage of the power output 108. The transformer 206 also electrically isolates the power input 102 from the power output 108 to prevent loads attached to the power output 108 from being exposed to the high voltage at the power input 102. A rectifier 208, such as a metal-oxide-semiconductor field effect transistor (MOSFET) bridge rectifier, is connected downstream from the transformer. The rectifier 208 is in electronic communication with the electronic controller 126 and converts the AC output of the transformer 206 to the lower DC voltage and sends it to an output filter 210. The output filter 210 removes noise from the lower power DC voltage that may be output from the rectifier 208 and sends the filtered lower power DC voltage to the power output 108.

The first and second DC/DC converters may also include one of the first or second current sensors 122, 124 as discussed above. The first and second DC/DC converters 104, 106 may include first and second temperature sensors 212, 214 in electronic communication with the electronic controller 126 that are configured to allow the electronic controller 126 to determine the temperatures of the first DC/DC converters 104, 106.

Each of the DC/DC converters 104, 106 are connected to the first and second voltage sensors 116, 118 at the power input 102 and the power output 108 respectively as discussed above.

The computer-readable medium may further contain instructions that, when executed by the electronic controller, cause the electronic controller to adjust the first output power of the first DC/DC converter and the second output power of the second DC/DC converter so that a difference between the first current through the first DC/DC converter and the second current through the second DC/DC converter are within a predetermined current range.

The computer-readable medium may further contain instructions that, when executed by the electronic controller, cause the electronic controller to perform one or more of the following functions:

Lower the first output power of the first DC/DC converter 104 and raise the second output power of the second DC/DC converter 106 when the temperature of the first DC/DC converter detected by the first temperature sensor 212 exceeds a first predetermined temperature threshold.

Raise the first output power of the first DC/DC converter 104 and lower the second output power of the second DC/DC converter 106 when the temperature of the second DC/DC converter detected by the second temperature sensor 214 exceeds a second predetermined temperature threshold.

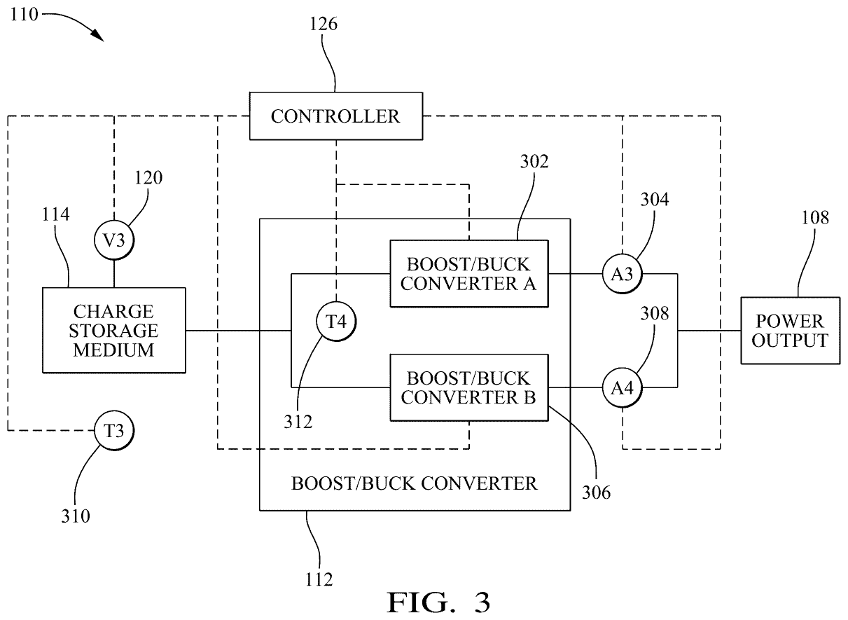

As shown in FIG. 3, the boost/buck DC/DC converter 112 may be an interleaved boost/buck DC/DC converter including a first boost/buck DC/DC converter 302 having a third current sensor 304 configured to allow the electronic controller 126 to determine a third current through the first boost/buck DC/DC converter 302 and a second boost/buck DC/DC converter 306 having a fourth current sensor 308 configured to allow the electronic controller 126 to determine a fourth current through the second boost/buck DC/DC converter 306. The electrical charge storage device 110 may also include a third temperature sensor 310 that is configured to allow the electronic controller 126 to determine a temperature of the energy storage medium 114 and include a fourth temperature sensor 312 that is configured to allow the electronic controller 126 to determine a fourth temperature of the boost/buck DC/DC converters 302, 306.

The first boost/buck DC/DC converter 302 and the second boost/buck DC/DC converter 306 being interleaved means that the first boost/buck DC/DC converter 302 operates 180 degrees out of phase with the second boost/buck DC/DC converter 306. This interleaving operation of the first boost/buck DC/DC converter 302 and the second boost/buck DC/DC converter 306 may provide significant reduction of electromagnetic interference (EMI) produced by the first boost/buck DC/DC converter 302 and the second boost/buck DC/DC converter 306.

The computer-readable medium may further contain instructions that, when executed by the electronic controller, cause the electronic controller to perform one or more of the following functions:

Adjust a first portion of the third output power from the first boost/buck DC/DC converter 302 based on the third current and the second and third voltages when the second voltage is outside a predetermined voltage range, and

Adjust a second portion of the third output power from the second boost/buck DC/DC converter 306 based on the fourth current and the second and third voltages when the second voltage is outside a predetermined voltage range.

The computer-readable medium may further contain instructions that, when executed by the electronic controller, cause the electronic controller to perform one or more of the following functions:

Adjust the third output power of the boost/buck DC/DC converter when the third temperature of the charge storage medium 114 exceeds a third predetermined temperature threshold.

Adjust the first output power of the first DC/DC converter 104 and the second output power of the second DC/DC converter 106 so that the temperatures of the first and second DC/DC converters detected by the first and second temperature sensors 212, 214 are within a predetermined temperature range.

The electronic controller 126 may be a single monolithic device, or it may be implemented using a number of electronically interconnected devices. In a first example, each of the first and second DC/DC converters 104, 106 has a dedicated electronic controller. These dedicated electronic controllers may also be in electronic communication with the electrical charge storage device 110 and configured to separately or cooperatively control the boost/buck converter(s) 112. If either of the dedicated electronic controllers of the DC/DC converters 104, 106 fail, the required power can still be provided by the remaining converter.

In a second example, each of the first and second DC/DC converters 104, 106 has a local electronic controller in electronic communication with a supervisory controller. The supervisory controller may also be in electronic communication with the electrical charge storage device 110 and configured to control the boost/buck converter(s) 112. The supervisory controller may include two separate and redundant processors to ensure operation of the electrical power supply.

The electrical power supply 100 may be configured so that half of the high voltage battery stack powers each of the first and second DC/DC converters 104, 106, e.g., an 800 volt power supply would supply 400 volts to the first DC/DC converter and 400 volts to the second DC/DC converter. The supervisory controller manages the overall power flow of the first DC/DC converter, the second DC/DC converter, and the electrical charge storage device, to prevent overstress of the individual components, preserve the life of charge storage cells in the electrical charge storage device and ensure that the proper power level is delivered.

The voltage sensors 116, 118, 120, the current sensors 122, 124, 304, 308, and the temperature sensors 212, 214, 310, 312 discussed above are used to determine the health of the first DC/DC converter 104, the second DC/DC converter 106, and the electrical charge storage device 110.

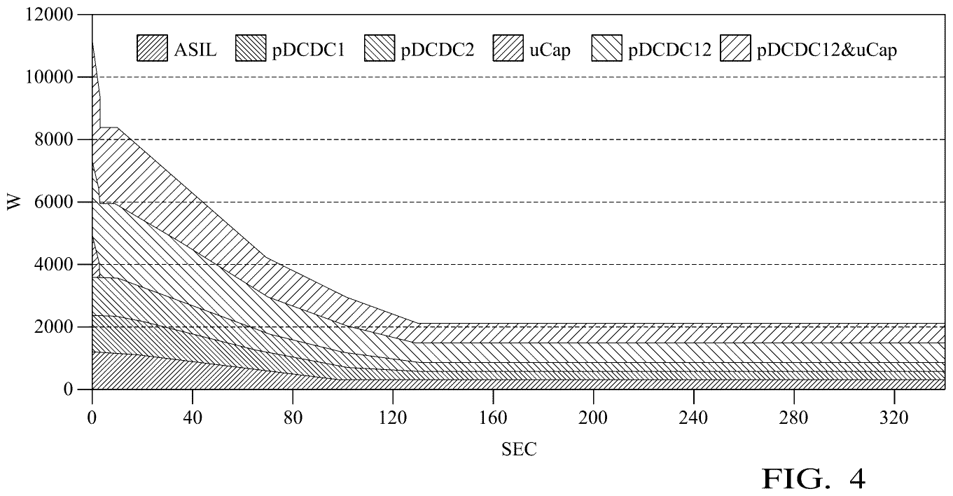

As shown in FIG. 4, each of first DC/DC converter 104, the second DC/DC converter 106, and the electrical charge storage device 110 has the capability of separately providing the power requirements. For the electrical charge storage device 110, that capability is provided for a limited time, e.g., 10 to 20 seconds.

The transient and steady state power capability can be reduced to reduce the overall cost as compared to individual ASIL B (D) components in the vehicle. For example, an ASIL load set which requires 600 W transient and 300 W continuous. A typical external power source may need be sized to provide 1000 W transient and 600 W continuous to meet those requirements. However, in the electrical power supply 100 presented herein, the first and second DC/DC converters may each be sized to provide 600 W transient and 300 W continuous. In the event of a failure of one of the DC/DC converters 104, 106 the remaining DC/DC converter 106, 104 can be used to fully provide power for the ASIL loads with the electrical charge storage device 110 acting as a backup. In the case of loss of the high voltage power supply (or failure of both DC/DC converters 104 and 106), the electrical charge storage device 110 may be capable of providing all the required power to the ASIL loads for 10 to 20 seconds.

The power output 108 may combine the power output from the first and second DC/DC converters 104, 106 and the electrical charge storage device 110 at a single terminal. Alternatively, the power output could contain switches (not shown), e.g., metal-oxide-semiconductor field effect transistors (MOSFETs), to direct the power to the ASIL or other loads, such as QM loads, as desired. QM stands for “Quality Management” level. QM level means that all assessed risks from inoperability of a particular load are tolerable from a safety perspective, e.g., power seats, interior lighting, etc. Therefore, safety assurance controls are unnecessary for QM loads and meeting ASIL level standards is not required for these QM loads.

In some embodiments, the DC/DC converters such as 104 and 106 are not bi-directional so when the loads connected to output power 108 are turned off the magnetic field collapse of those loads can be “bucked” into the charge storage medium 114

The electronic controller 126 may be configured to prioritize operation in the following manner:
1) Providing power to the electrical loads connected to the electrical power supply at a reliability level sufficient to meet the ASIL-D rating.
2) Allow the desired voltage range to be resettable by the external electronic controller 128 via a communication bus, e.g., CAN or LIN.
3) Provide overvoltage protection of the power output 108 to protect the electrical loads connected to the electrical power supply 100.
4) Maintain reserve capacity in the electrical charge storage device 110 to provide current and future power needs.
5) Monitor operation of the electrical power supply 100 to ensure that all components are operating below their safety limits.
6) Monitor operation of the electrical power supply 100 to maximize operational lifetime for all components.

The electronic controller 126 may be further configured to:
a) React to failures in any one of the first DC/DC converter 104, the second DC/DC converter 106, or the electrical charge storage device 110.
b) Balance the voltage of ultracapacitor cells in the charge storage medium 114.
c) Blend the surge requirements with the steady state requirements by using power from both DC/DC converters 104, 106 and the electrical charge storage device 110 to maximize component lifetimes.

While the examples of the electrical power supply presented herein are directed to automotive applications, other embodiments of the electrical power supply may be used in other application requiring a robust and reliable power supply.

### Discussion of Possible Embodiments

The following are nonexclusive descriptions of possible embodiments of the present invention.

In some aspects, the techniques described herein relate to an electrical power supply assembly. The electrical power supply assembly includes a first direct current-to-direct current (DC/DC) converter having a first current sensor configured to determine a first current through the first DC/DC converter and a second DC/DC converter having a second current sensor configured to determine a second current through the second DC/DC converter. The electrical power supply assembly further includes an electrical charge storage device having a boost/buck DC/DC converter and a charge storage medium, a first voltage sensor configured to determine a first voltage of an input of the electrical power supply assembly, a second voltage sensor configured to determine a second voltage of an output of the electrical power supply assembly, and a third voltage sensor configured to determine a third voltage of the charge storage medium. The electrical power supply assembly additionally includes an electronic controller in electronic communication with the first and second DC/DC converters, the boost/buck DC/DC converter, the first, second, and third voltage sensors, and the first and second current sensors. The electronic controller includes a computer-readable medium that stores instructions that, when executed by the electronic controller, cause the electronic controller to perform one or more of the following functions: adjust a first output power of the first DC/DC converter based on the first current and the first and second voltages when the second voltage is outside a predetermined voltage range, adjust a second output power of the second DC/DC converter based on the second current and the first and second voltages when the second voltage is outside the predetermined voltage range, and adjust a third output power of the boost/buck DC/DC converter based on the second and third voltages when the second voltage is outside the predetermined voltage range.

The assembly of the preceding paragraph can optionally include, additionally and/or alternatively any, one or more of the following features/steps, configurations and/or

In some aspects, the techniques described herein relate to an assembly, wherein the electronic controller is configured to receive the predetermined voltage range from a device external to the electrical power supply assembly when the external device is in electronic communication with the electronic controller.

In some aspects, the techniques described herein relate to an assembly, wherein the computer-readable medium further contains instructions that, when executed by the electronic controller, cause the electronic controller to operate the boost/buck DC/DC converter in buck mode to suppress voltage spikes and hold the second voltage within the predetermined voltage range.

In some aspects, the techniques described herein relate to an assembly, wherein the charge storage medium includes an ultracapacitor.

In some aspects, the techniques described herein relate to an assembly, wherein the first DC/DC converter includes a first temperature sensor configured to determine a first temperature of the first DC/DC converter, the second DC/DC converter includes a second temperature sensor configured to determine a second temperature of the second DC/DC converter, and the electrical charge storage device includes a third temperature sensor configured to determine a third temperature of the electrical charge storage device and wherein the computer-readable medium further contains instructions that, when executed by the electronic controller, cause the electronic controller to perform one or more of the following functions: lower the first output power of the first DC/DC converter and raise the second output power of the second DC/DC converter when the first temperature exceeds a first predetermined threshold, raise the first output power of the first DC/DC converter and lower the second output power of the second DC/DC converter when the second temperature exceeds a second predetermined threshold, adjust the third output power of the boost/buck DC/DC converter when the third temperature exceeds a third predetermined threshold, and adjust the first output power of the first DC/DC converter and the second output power of the second DC/DC converter so that the first temperature and the second temperature are within a predetermined temperature range.

In some aspects, the techniques described herein relate to an assembly, wherein the computer-readable medium further contains instructions that, when executed by the electronic controller, cause the electronic controller to adjust the first output power of the first DC/DC converter and the second output power of the second DC/DC converter so that a difference between the first current and the second current are within a predetermined current range.

In some aspects, the techniques described herein relate to an assembly, wherein the boost/buck DC/DC converter includes a first boost/buck DC/DC converter having a third current sensor configured to determine a third current through the first boost/buck DC/DC converter and a second boost/buck DC/DC converter having a fourth current sensor configured to determine a fourth current through the second boost/buck DC/DC converter, the first boost/buck DC/DC converter, the third current sensor, the second boost/buck DC/DC converter and the fourth current sensor in electronic communication with the electronic controller and wherein the computer-readable medium further contains instructions that, when executed by the electronic controller, cause the electronic controller to: adjust a first portion of the third output power from the first boost/buck DC/DC converter based on the third current and the second and third voltages when the second voltage is outside a predetermined voltage range, and adjust a second portion of the third output power from the second boost/buck DC/DC converter based on the fourth current and the second and third voltages when the second voltage is outside a predetermined voltage range.

In some aspects, the techniques described herein relate to an assembly, wherein the first DC/DC converter includes a first portion of the electronic controller, and the second DC/DC converter includes a second portion of the electronic controller.

In some aspects, the techniques described herein relate to an assembly, wherein the first portion of the electronic controller is in electronic communication with the first boost/buck DC/DC converter and controls the first boost/buck DC/DC converter, and the second portion of the electronic controller is in electronic communication with the second boost/buck DC/DC converter and controls the second boost/buck DC/DC converter.

In some aspects, the techniques described herein relate to an assembly, wherein the first boost/buck DC/DC converter is interleaved with the second boost/buck DC/DC converter and the first boost/buck DC/DC converter operates 180 degrees out of phase with the second boost/buck DC/DC converter.

In some aspects, the techniques described herein relate to an automotive electrical power supply configured to supply electrical power to at least one Automotive Safety Integrity Level (AISL) D classified electrical load in a vehicle at a predetermined power level. The automotive electrical power supply includes a first DC/DC converter configured to supply a first portion of the electrical power. The first DC/DC converter is configured to supply the first portion of the electrical power at least at the predetermined power level. The automotive electrical power supply has a second DC/DC converter configured to supply a second portion of the electrical power. The second DC/DC converter is configured to supply the second portion of the electrical power at least at the predetermined power level. The automotive electrical power supply also includes an electrical charge storage device configured to supply a third portion of the electrical power. The electrical charge storage device is configured to supply the third portion of the electrical power for a predetermined time period at least at the predetermined power level. The automotive electrical power supply further includes an electronic controller in electronic communication with the first and second DC/DC converters and the electrical charge storage device. The electronic controller is configured to perform one or more of the following functions: adjust operation of the first DC/DC converter to cause the automotive electrical power supply to maintain the predetermined power level, adjust operation of the second DC/DC converter to cause the automotive electrical power supply to maintain the predetermined power level, and adjust operation of the electrical charge storage device to cause the automotive electrical power supply to maintain the predetermined power level at least for the predetermined time period.

The power supply of the preceding paragraph can optionally include, additionally and/or alternatively any, one or more of the following features/steps, configurations and/or

In some aspects, the techniques described herein relate to a power supply, wherein the electronic controller is configured to receive the predetermined power level from a device external to the electrical power supply when the external device is in electronic communication with the electronic controller.

In some aspects, the techniques described herein relate to a power supply, wherein a sum of the first portion of the electrical power, the second portion of the electrical power, and the third portion of the electrical power is equal to the predetermined power level.

In some aspects, the techniques described herein relate to a power supply, wherein the first DC/DC converter includes a first temperature sensor configured to determine a first temperature of the first DC/DC converter, the second DC/DC converter includes a second temperature sensor configured to determine a second temperature of the second DC/DC converter, and the electrical charge storage device includes a third temperature sensor configured to determine a third temperature of the electrical charge storage device and wherein the electronic controller is further configured to perform one or more of the following functions: lower a first output power of the first DC/DC converter and raise a second output power of the second DC/DC converter when the first temperature exceeds a first predetermined threshold, raise the first output power of the first DC/DC converter and lower the second output power of the second DC/DC converter when the second temperature exceeds a second predetermined threshold, and adjust the first output power of the first DC/DC converter and the second output power of the second DC/DC converter so that the first temperature and the second temperature are within a predetermined temperature range.

In some aspects, the techniques described herein relate to a power supply, wherein the electronic controller is further configured to adjust a first output power of the first DC/DC converter and a second output power of the second DC/DC converter so that a difference between a first current through the first DC/DC converter and a second current through the second DC/DC converter are within a predetermined current range.

In some aspects, the techniques described herein relate to a power supply, wherein the electrical charge storage device includes a boost/buck DC/DC converter and a charge storage medium and wherein the electronic controller is further configured to operate the boost/buck DC/DC converter in buck mode to inhibit an output voltage of the power supply from exceeding a predetermined voltage threshold.

In some aspects, the techniques described herein relate to a power supply, wherein the charge storage medium includes an ultracapacitor.

In some aspects, the techniques described herein relate to a power supply, wherein the electronic controller includes two separate microprocessor devices.

In some aspects, the techniques described herein relate to a power supply, wherein the electrical charge storage device includes a first boost/buck DC/DC converter and a separate second boost/buck DC/DC converter and wherein the first boost/buck DC/DC converter is interleaved with the second boost/buck DC/DC converter such that the first boost/buck DC/DC converter operates 180 degrees out of phase with the second boost/buck DC/DC converter.

In some aspects, the techniques described herein relate to a power supply, wherein a first microprocessor of the electronic controller controls the first boost/buck DC/DC converter, and a second microprocessor of the electronic controller controls the second boost/buck DC/DC converter.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”′ is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical power supply assembly, comprising:
a first direct current-to-direct current (DC/DC) converter having a first current sensor configured to determine a first current through the first DC/DC converter;
a second DC/DC converter having a second current sensor configured to determine a second current through the second DC/DC converter;
an electrical charge storage device comprising a boost/buck DC/DC converter and a charge storage medium;
a first voltage sensor configured to determine a first voltage of an input of the electrical power supply assembly;
a second voltage sensor configured to determine a second voltage of an output of the electrical power supply assembly;
a third voltage sensor configured to determine a third voltage of the charge storage medium;
an electronic controller in electronic communication with the first and second DC/DC converters, the boost/buck DC/DC converter, the first, second, and third voltage sensors, and the first and second current sensors, said electronic controller comprising a computer-readable medium that stores instructions that, when executed by the electronic controller, cause the electronic controller to perform one or more of the following functions:
adjust a first output power of the first DC/DC converter based on the first current and the first and second voltages when the second voltage is outside a predetermined voltage range,
adjust a second output power of the second DC/DC converter based on the second current and the first and second voltages when the second voltage is outside the predetermined voltage range, and
adjust a third output power of the boost/buck DC/DC converter based on the second and third voltages when the second voltage is outside the predetermined voltage range.

2. The assembly in accordance with claim 1, wherein the electronic controller is configured to receive the predetermined voltage range from a device external to the electrical power supply assembly when the external device is in electronic communication with the electronic controller.

3. The assembly in accordance with claim 1, wherein the computer-readable medium further contains instructions that, when executed by the electronic controller, cause the electronic controller to operate the boost/buck DC/DC converter in buck mode to suppress voltage spikes and hold the second voltage within the predetermined voltage range.

4. The assembly in accordance with claim 1, wherein the charge storage medium comprises an ultracapacitor.

5. The assembly in accordance with claim 1, wherein the first DC/DC converter comprises a first temperature sensor configured to determine a first temperature of the first DC/DC converter, said second DC/DC converter comprises a second temperature sensor configured to determine a second temperature of the second DC/DC converter, and the electrical charge storage device comprises a third temperature sensor configured to determine a third temperature of the electrical charge storage device and wherein the computer-readable medium further contains instructions that, when executed by the electronic controller, cause the electronic controller to perform one or more of the following functions:
lower the first output power of the first DC/DC converter and raise the second output power of the second DC/DC converter when the first temperature exceeds a first predetermined threshold,
raise the first output power of the first DC/DC converter and lower the second output power of the second DC/DC converter when the second temperature exceeds a second predetermined threshold,
adjust the third output power of the boost/buck DC/DC converter when the third temperature exceeds a third predetermined threshold, and
adjust the first output power of the first DC/DC converter and the second output power of the second DC/DC converter so that the first temperature and the second temperature are within a predetermined temperature range.

6. The assembly in accordance with claim 1, wherein the computer-readable medium further contains instructions that, when executed by the electronic controller, cause the electronic controller to adjust the first output power of the first DC/DC converter and the second output power of the second DC/DC converter so that a difference between the first current and the second current are within a predetermined current range.

7. The assembly in accordance with claim 1, wherein the boost/buck DC/DC converter comprises a first boost/buck DC/DC converter having a third current sensor configured to determine a third current through the first boost/buck DC/DC converter and a second boost/buck DC/DC converter having a fourth current sensor configured to determine a fourth current through the second boost/buck DC/DC converter, the first boost/buck DC/DC converter, the third current sensor, the second boost/buck DC/DC converter and the fourth current sensor in electronic communication with the electronic controller and wherein the computer-readable medium further contains instructions that, when executed by the electronic controller, cause the electronic controller to:
adjust a first portion of the third output power from the first boost/buck DC/DC converter based on the third current and the second and third voltages when the second voltage is outside a predetermined voltage range, and
adjust a second portion of the third output power from the second boost/buck DC/DC converter based on the fourth current and the second and third voltages when the second voltage is outside a predetermined voltage range.

8. The assembly in accordance with claim 7, wherein the first DC/DC converter comprises a first portion of the electronic controller and the second DC/DC converter comprises a second portion of the electronic controller.

9. The assembly in accordance with claim 8, wherein the first portion of the electronic controller is in electronic communication with the first boost/buck DC/DC converter and controls the first boost/buck DC/DC converter, and the second portion of the electronic controller is in electronic communication with the second boost/buck DC/DC converter and controls the second boost/buck DC/DC converter.

10. The assembly in accordance with claim 7, wherein the first boost/buck DC/DC converter is interleaved with the second boost/buck DC/DC converter and the first boost/buck DC/DC converter operates 180 degrees out of phase with the second boost/buck DC/DC converter.

11. An automotive electrical power supply configured to supply electrical power to at least one Automotive Safety Integrity Level (AISL) D classified electrical load in a vehicle at a predetermined power level, said automotive electrical power supply comprising:
a first DC/DC converter configured to supply a first portion of the electrical power, said first DC/DC converter being configured to supply the first portion of the electrical power at least at the predetermined power level;
a second DC/DC converter configured to supply a second portion of the electrical power, said second DC/DC converter being configured to supply the second portion of the electrical power at least at the predetermined power level;
an electrical charge storage device configured to supply a third portion of the electrical power, said electrical charge storage device being configured to supply the third portion of the electrical power for a predetermined time period at least at the predetermined power level;
an electronic controller in electronic communication with the first and second DC/DC converters and the electrical charge storage device, said electronic controller being configured to perform one or more of the following functions:
adjust operation of the first DC/DC converter to cause the automotive electrical power supply to maintain the predetermined power level,
adjust operation of the second DC/DC converter to cause the automotive electrical power supply to maintain the predetermined power level, and
adjust operation of the electrical charge storage device to cause the automotive electrical power supply to maintain the predetermined power level at least for the predetermined time period.

12. The automotive electrical power supply in accordance with claim 11, wherein the electronic controller is configured to receive the predetermined power level from a device external to the electrical power supply when the external device is in electronic communication with the electronic controller.

13. The automotive electrical power supply in accordance with claim 11, wherein a sum of the first portion of the electrical power, the second portion of the electrical power, and the third portion of the electrical power is equal to the predetermined power level.

14. The automotive electrical power supply in accordance with claim 11, wherein the first DC/DC converter comprises a first temperature sensor configured to determine a first temperature of the first DC/DC converter, said second DC/DC converter comprises a second temperature sensor configured to determine a second temperature of the second DC/DC converter, and the electrical charge storage device comprises a third temperature sensor configured to determine a third temperature of the electrical charge storage device and wherein the electronic controller is further configured to perform one or more of the following functions:
lower a first output power of the first DC/DC converter and raise a second output power of the second DC/DC converter when the first temperature exceeds a first predetermined threshold,
raise the first output power of the first DC/DC converter and lower the second output power of the second DC/DC converter when the second temperature exceeds a second predetermined threshold, and
adjust the first output power of the first DC/DC converter and the second output power of the second DC/DC converter so that the first temperature and the second temperature are within a predetermined temperature range.

15. The automotive electrical power supply in accordance with claim 11, wherein the electronic controller is further configured to adjust a first output power of the first DC/DC converter and a second output power of the second DC/DC converter so that a difference between a first current through the first DC/DC converter and a second current through the second DC/DC converter are within a predetermined current range.

16. The automotive electrical power supply in accordance with claim 11, wherein the electrical charge storage device comprises a boost/buck DC/DC converter and a charge storage medium and wherein the electronic controller is further configured to operate the boost/buck DC/DC converter in buck mode to inhibit an output voltage of the power supply from exceeding a predetermined voltage threshold.

17. The automotive electrical power supply in accordance with claim 16, wherein the charge storage medium comprises an ultracapacitor.

18. The automotive electrical power supply in accordance with claim 11, wherein the electronic controller comprises two separate microprocessor devices.

19. The automotive electrical power supply in accordance with claim 11, wherein the electrical charge storage device comprises a first boost/buck DC/DC converter and a separate second boost/buck DC/DC converter and wherein the first boost/buck DC/DC converter is interleaved with the second boost/buck DC/DC converter such that the first boost/buck DC/DC converter operates 180 degrees out of phase with the second boost/buck DC/DC converter.

20. The automotive electrical power supply in accordance with claim 19, wherein a first microprocessor of the electronic controller controls the first boost/buck DC/DC converter, and a second microprocessor of the electronic controller controls the second boost/buck DC/DC converter.
